(19) United States
(12) Patent Application Publication
(10) Pub. No.: US 2003/0085872 A1
(43) Pub. Date: May 8, 2003

(54) Recording of information

(76) Inventor: Christer Fahraeus, Lund (SE)

Correspondence Address: NORMAN H. ZIVIN, Cooper & Dunham LLP, 1185 Avenue of the Americas, New York, NY, 10036, US

(21) Appl. No.: 10/322,323

(22) Filed: Dec. 18, 2002

Related U.S. Application Data
(63) Continuation of application No. 09/605,095, filed on Jun. 27, 2000, now abandoned.
(60) Provisional application No. 60/144,715, filed on Jul. 20, 1999.

(30) Foreign Application Priority Data
Jun. 28, 1999 (SE) 9902437-4

(51) Int. Cl. G09G 5/08

(52) U.S. Cl. 345/158

(57) ABSTRACT

A handheld computer system is divided into a handheld computer unit (1) and a separate handheld display unit (2). The computer unit is adapted to communicate in a wireless manner with the display unit. Essentially all processing and storing of information take place in the computer unit while the display unit is merely used to show information.

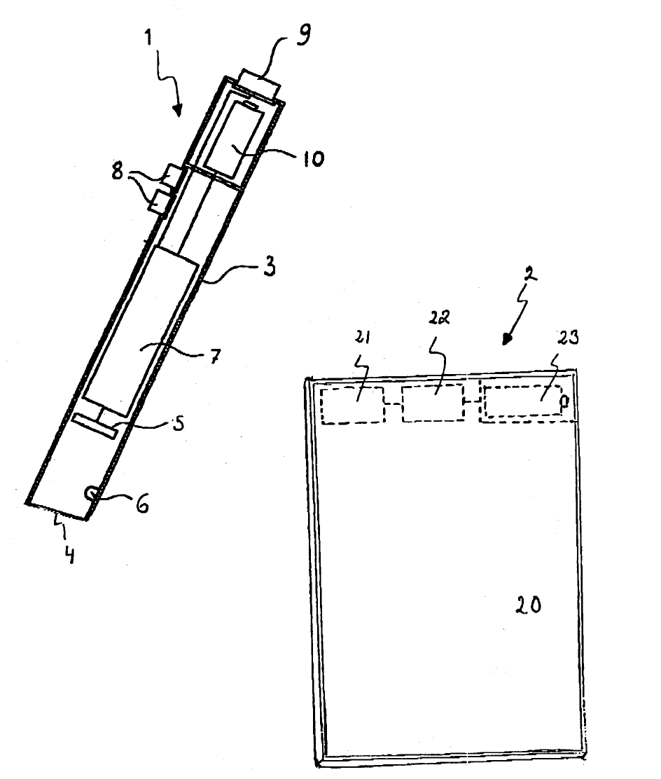

### FIELD OF THE INVENTION

The present invention relates to a handheld computer system and a display unit with a display for showing information.

### BACKGROUND OF THE INVENTION

Handheld computers, i.e. computers that are so small as to be held in the user's hand, have become increasingly popular. They are usually rectangular and fairly thin. They contain a processor for processing of information, a memory for permanent storing of information, a means for inputting of information and instructions to the processor unit, and a means for outputting information. As a rule, the means for outputting information is a display. Sometimes the display is contact-sensitive so that the display can also be used for the inputting of information and instructions by acting on the display, in many cases by means of a pen. This technique of inputting information, however, can only be used for small amounts of information since it is fairly complicated and time-consuming. In some handheld computers, the means for inputting information is a small keyboard instead. The buttons are usually very small. For a user who is accustomed to operate with a normal-sized keyboard for a personal computer, it is inconvenient to use the keyboard of the handheld computer and errors frequently arise.

Furthermore WO 98/20446 discloses a handheld computer or handheld reading pen which has the shape of a highlighter pen and which is intended for selective recording of information, preferably text. It contains a light-sensitive area sensor, which is adapted to record images with partially overlapping contents. A processor unit uses the partially overlapping contents of the images to put them together to a composite image. OCR software converts the characters in the composite image to character-coded format. The recorded text can be shown on a display, which is located on the side of the reading pen. Instructions to the processor unit can be supplied via buttons on the reading pen.

This prior-art reading pen enables quick recording of large amounts of information. However, it is less suited for showing the information. In fact contradictory requirements are placed on the display. On the one hand, it should be as small as possible for the reading pen to be made narrower and thinner and resemble a pen. On the other hand, it should be made as large as possible so that as much information as possible can be shown at the same time.

The same problem occurs with other pen-shaped handheld computers, such as different kinds of electronic pens, which can record hand-written information by detecting the movement of the pen with the aid of accelerometers or optically, e.g. with the aid of a pattern or code on a writing surface.

### SUMMARY OF THE INVENTION

An object of the present invention is to wholly or partially obviate the above problems.

This object is achieved by a handheld computer system according to claim 1 and a display unit according to claim 15.

More specifically the invention concerns a handheld computer system, which is divided into a handheld computer unit and a separate handheld display unit, the computer unit being adapted to communicate in a wireless manner with the display unit.

Thus the computer unit and the display unit are arranged in two separate physical casings. As a result, the display unit can be made as large as desired so that a large amount of information can be shown at the same time. Simultaneously the computer unit can be made as small as allowed by the components included therein, thereby making it easy to carry along and comfortable to use. The computer unit may, but need not, include a display. It can for instance have a very small display for use only when the display unit is not available. Preferably it does not, however, have any display, so that the computer unit can be made as small as wanted and so that no switching need to be carried out between different displays.

It should be emphasised that the display unit is handheld so that a really mobile handheld computer system is obtained. However, “handheld” should not be interpreted in the literal sense. It should be interpreted to also encompass displays held on other parts of the body, such as a display held on the arm or on the head of the user, e.g. in the form of a pair of glasses.

Another advantage with a display unit separate from the computer unit is that information need not always by shown on the handheld display unit included in the handheld computer system, but more specifically the information can be shown on any display whatever that can handle the communication with the computer unit. Thus this display can be, for instance, a television screen or a personal computer display provided with suitable communication and drive circuits. This means that the user can choose the display on which he wants to show the information and therefore he need not always carry along the display unit included in the handheld computer system, but only the handheld computer unit.

A further advantage is that it will be possible to upgrade the display unit or replace a damaged display unit without replacing the entire handheld computer system.

Yet another advantage is that the computer unit may contain a lighter and cheaper battery.

The wireless communication can be effected, for instance, by using radiowaves according to the BlueTooth standard, via IR light or via body transmission or via ultrasound.

The computer unit preferably comprises a sensor for inputting information, a processor unit for processing the information with a memory for permanent storing of information and circuitry for the wireless communication with the display unit. The sensor may be any sensor enabling the recording of information in a simple way so that there is no need for a keyboard. By memory for permanent storing of information is here meant a memory which stores such information as has been inputted by the user when the computer unit is switched off.

The sensor is preferably an optical sensor, which makes it possible to scan information from a sheet of paper and other sources of information, in which case large amounts of information can be recorded in a simple way.

The display unit suitably comprises a display and circuitry for wireless communication with the computer unit. In addition, it preferably comprises essentially only components, hardware and software, for driving and controlling the display.

In this embodiment, the display unit thus is an essentially “unintelligent” unit which only serves to show information that is being transmitted to it from the computer unit. By “unintelligent”, however, is not meant that it must completely lack processor capacity since, for instance, the circuitry for the wireless communication with the computer unit may very well contain a processor. The components for driving and controlling the display may also contain logic for processing graphic instructions from the computer unit at different levels, anything from instructions whether an individual pixel should be on or off to instructions at a higher level, for instance that the information on the display is to be scrolled. On the other hand, the display unit is “unintelligent” in the sense that it cannot be used independently of a computer unit.

Preferably the display unit essentially lacks a memory for permanent storing of information. By “essentially” is here meant that the display unit does not have a memory for storing of documents, directories, diaries, dictionaries or similar user programs and user data. However, the display unit can possibly have a memory which permits permanent storing of display settings or the like which only concern the showing of information and which need not be available to the user when the display unit is not in use.

In one embodiment, the display in the display unit can be a contact-sensitive display and the display unit can be arranged to transfer information recorded via the contact-sensitive display to the computer unit.

This has the advantage that a user can input information via the computer unit as well as via the display unit. In this case, information inputted via the display unit is preferably transmitted directly to the computer unit and processed therein, so that the display unit need not contain any components for processing or storing the inputted information.

The handheld computer system thus is preferably arranged in such manner that essentially all information processing occurring in the system occurs in the computer unit. Consequently, the computer unit is a complete unit except for the display and can be used separately, for instance, for recording of information in the cases where showing on a display is not necessary. By essentially all processing of information is here meant all processing of information except the above-mentioned possible processing of graphic instructions and, if necessary, the processing of information which is inputted via the display, for transmission thereof to the computer unit. As already mentioned, the computer unit may as an alternative have a very small display which, if need be, can be used when the display unit is not available. In the alternative or as a supplement it may have one or more LED's or other indicator means for providing feed-back to the user.

The handheld computer system is further arranged so that essentially all information stored in the system is stored in the memory in the computer unit. Thus, all information is available to the user when he brings along the computer unit. He may then choose, for instance, to have one display unit at home and one at work and avoid bringing along the display unit. Of course the computer unit may however be arranged so that it enables transfer of information, in particular user data, to other computer units, such as a stationary PC.

The computer unit can advantageously have the shape of a pen, thus making it easy to use as a reading pen.

The handheld computer system can constitute a PDA (Personal Digital Assistant), i.e. a computer used to keep up with personal information, such as diary information and directory information.

The computer unit is advantageously adapted to permit at least one of the functions selected from the group consisting of recording of handwritten text, operating a cursor on the display, recording of handwritten figures, recording of text and storing thereof in character-coded format, and recording of images. With one or more of these functions, excellent possibilities of inputting different types of information into the handheld computer system are obtained.

To accomplish the above-mentioned functions as well as other functions, the optical sensor is advantageously adapted to record images with partially overlapping contents. By the images overlapping, they contain information about how they are related to each other. From this information, it is possible to determine, for instance, how the computer unit has been moved, which is of interest when recording handwritten text and handdrawn figures and when operating the cursor on the display. Further the computer unit need not contain any specific position sensors, such as wheels or the like, which are normally used in handheld scanners to determine how recorded images or image data are related to each other.

According to a second aspect, the invention concerns a display unit comprising a display for showing information. The display unit is handheld and comprises circuitry for wireless reception of the information that is to be shown on the display.

The advantages of this display unit have been mentioned above.

### BRIEF DESCRIPTION OF THE DRAWING

The present invention will now be described in more detail by way of an example with reference to the accompanying drawing, in which the only FIGURE shows an embodiment of a handheld computer system according to the invention.

### DESCRIPTION OF A PREFERRED EMBODIMENT

A handheld computer system as shown in the drawing comprises a computer unit 1 and a display unit 2.

The handheld computer unit 1 has essentially the shape of a pen. It has a casing 3, which in one short side has an opening 4.

Inside the opening 4 there is a light-sensitive area sensor 5 which may consist of, for instance, a CCD sensor or a CMOS sensor, and at least one LED 6 which is adapted to illuminate, when required, a surface to which the opening 4 is directed.

The sensor 5 is connected with a processor unit 7, which comprises a processor that is programmed to process information recorded, among other things, by the sensor 5, and a memory for permanent storing of the information.

The processor unit 7 is connected to buttons 8 which are placed in the casing 3 and which are used to switch on and off the device and to give instructions to the processor unit.

The processor unit 7 is further connected with a communication circuit 9 which communicates according to the BlueTooth standard with the display unit 2.

Finally, the casing contains a battery 10 which supplies the various electronic components in the computer unit 1 with current.

WO 98/20446 as mentioned by way of introduction discloses a handheld reading pen which can be used as computer unit in a handheld computer system if supplemented with software for transmitting information to be shown to a separate handheld display unit.

The display unit 2 comprises a thin LCD display 20, a communication circuit 21 communicating according to the BlueTooth standard with the computer unit 1, drive and control circuits 22 for the display, and a battery 23 for supplying the display unit with current.

The handheld computer system operates as follows. Assume that a user has obtained a business card and wants to record the name and address of the person on the card in a directory program in the handheld computer system. The user then switches on the computer unit 1 and the display unit 2. By means of the buttons 8 the commands the processor unit 7 to start the directory program. As the program starts, it transmits information to the display unit 2 which shows the same information as would normally be shown if the display 20 had been integrated in the computer unit. Subsequently the user places the opening 4 in the casing 3 against the business card at the beginning of the line from which he wants to scan the name and address. He activates a text inputting program, whereby the LED 6 begins to generate strobe pulses at a predetermined frequency and the processor unit 7 reads images from the sensor at the same frequency. The user passes the computer unit 1 over the text that he wants to scan. As the images from the sensor 5 are recorded, the processor unit 7 puts them together to a composite image of the text. Here the overlapping contents of the images are used. More specifically, the processor unit 7 tests all conceivable overlap positions between two successively recorded images and determines in which position the best correspondence between the contents of the images is obtained. This position is selected for putting together the images. When the images have been put together to a composite image of the text, the individual letters in the image are identified and OCR software is used to determine which are the letters and store them in character-coded format as a name and an address in the memory. The result is shown on the display unit 2, which the user can comfortably hold in his other hand or let it rest on a surface. A more detailed description of how text can be recorded is to be found in the above-mentioned WO 98/20446.

The user can further use the computer unit 1 in a mouse mode to operate a cursor on the display 2. In this case, the relative positions of successively recorded images can be used to determine how the computer unit has been moved and, from this information, to determine control signals for controlling the cursor on the display.

The computer unit 1 can also be used to input handwritten text and handdrawn figures. It is then used in the same way as a pen, the sensor recording images with partially overlapping contents along the path of the computer unit. By means of the relative positions of the images, the processor unit 7 can determine how the computer unit has been moved and, thus, produce a digital description of the movement which can be stored and shown on the display.

It goes without saying that the computer unit may contain additional functions, such as diary programs, translation programs and the like, and further sensors.

The computer unit may also include an optical arrangement which makes it possible to record images at a larger distance by means of the sensor 5 or another sensor integrated in the computer unit. In this case the computer unit has thus a camera function, in connection with which the handheld display unit 2 may be very useful. When the user directs the computer unit 1 towards an object to be imaged, he can at the same time see the extent of the obtained image and the sharpness thereof on the display unit, which he holds in his hand.

In an alternative embodiment, the display unit has a contact-sensitive display 20 instead of an LCD display. The user can then input information via the display in the same manner as in prior-art handheld computer systems. The display unit contains in this case, however, only circuits for essentially receiving the information from the display and forwarding it to the computer unit, in which all processing and storing of the information take place.

In the description above, the invention is exemplified by an optical reading pen. As mentioned by way of introduction, the invention is however also applicable to any kind of handheld computer where a display is needed for showing recorded information.

1. A handheld computer system, characterised in that the handheld computer system is divided into a handheld computer unit (1) and a separate handheld display unit (2), the computer unit being adapted to communicate in a wireless manner with the display unit.

2. A handheld computer system as claimed in claim 1, wherein the computer unit comprises a sensor (5) for inputting information, a processor unit (7) for processing the information with a memory for permanent storing of the information, and circuitry (9) for wireless communication with the display unit.

3. A handheld computer system as claimed in claim 2, wherein the sensor is an optical sensor.

4. A handheld computer system as claimed in claim 1, 2 or 3, wherein the display unit (2) comprises a display (20) and circuitry (21) for wireless communication with the computer unit.

5. A handheld computer system as claimed in claim 4, wherein the display unit (2), in addition to the display (20) and the circuitry (21) for wireless communication, essentially contains merely components (22) for driving and controlling the display.

6. A handheld computer system as claimed in any one of the preceding claims, wherein the display unit (2) essentially lacks a memory for permanent storing of information.

7. A handheld computer system as claimed in any one of the preceding claims, wherein the display (20) is a contact-sensitive display and wherein the display unit (2) is arranged to transfer information recorded via the contact-sensitive display to the computer unit.

8. A handheld computer system as claimed in any one of the preceding claims, which is arranged so that essentially all processing of information occurring in the system occurs in the computer unit (1).

9. A handheld computer system as claimed in any one of the preceding claims, which is arranged so that essentially all information stored in the system is stored in the memory in the computer unit (1).

10. A handheld computer system as claimed in any one of the preceding claims, wherein the computer unit (1) has the shape of a pen.

11. A handheld computer system as claimed in any one of the preceding claims, wherein the handheld computer system is a PDA (Personal Digital Assistant).

12. A handheld computer system as claimed in any one of the preceding claims, wherein the computer unit (1) is adapted to permit at least one of the functions selected from the group consisting of recording of handwritten text, operating a cursor on the display, recording of handdrawn figures, recording of text and storing thereof in character-coded format, and recording of images.

13. A handheld computer system as claimed in any one of claims 3-12, wherein the optical sensor (5) is adapted to record images with partially overlapping contents.

14. A handheld computer system as claimed in any one of the preceding claims, wherein the computer unit lacks a display.

15. A display unit comprising a display for showing information, characterised in that the display unit (2) is handheld, and that it comprises circuitry (21) for wireless reception of the information that is to be shown on the display.

16. A display unit as claimed in claim 15, wherein the display unit, in addition to the display (20) and the circuitry (21) for wireless reception, essentially contains merely components (22) for driving and controlling the display.

17. A display unit as claimed in claim 15 or 16, wherein the display unit lacks a memory for permanent storing of the information.
